(19) United States
(12) Patent Application Publication
(10) Pub. No.: US 2006/0288343 A1
(43) Pub. Date: Dec. 21, 2006

(54) Methods and apparatus to enable remote-user-interface-capable managed runtime environments

(76) Inventor: Kim Pallister, Beaverton, OR (US)

Correspondence Address: HANLEY, FLIGHT & ZIMMERMAN, LLC, 20 N. WACKER DRIVE, SUITE 4220, CHICAGO, IL, 60606, US

(21) Appl. No.: 11/156,386

(22) Filed: Jun. 20, 2005

(51) Int. Cl. G06F 9/44

(52) U.S. Cl. 717/168

(57) ABSTRACT

Methods and apparatus to enable remote-user-interface-capable managed runtime environments are disclosed. A disclosed example method includes receiving a request from a first device to execute an application at a second device, the first device being incapable of executing the application. The method further includes retrieving the application from an application library, executing the application on the second device in a managed runtime environment, transmitting at least a portion of the interface of the application from the second device to the first device, and presenting the interface of the application the first device.

### TECHNICAL FIELD

The present disclosure pertains to managed runtime environments and, more particularly, to methods and apparatus to enable remote-user-interface-capable managed runtime environments.

### BACKGROUND

The need for increased software application portability (i.e., the ability to execute a given software application on a variety of platforms having different hardware, operating systems, etc.), and the need to reduce time to market for independent software vendors (ISVs), have resulted in increased development and usage of managed runtime environments and virtual machines.

Virtual machines (VMs) are typically implemented using a dynamic programming language such as, for example, Java, C#, J#, VB.NET, and Jscript .NET. A software engine (e.g., a Java Virtual Machine (JVM) and Microsoft .NET Common Language Runtime (CLR), etc.), which is commonly referred to as a runtime environment, executes the dynamic program language instructions of the managed application. The VM interfaces dynamic program language instructions (e.g., a Java program or source code) to be executed to a target platform (i.e., the hardware and operating system(s) of the computer executing the dynamic program) so that the dynamic program can be executed in a platform independent manner.

Dynamic program language instructions (e.g., Java instructions) are not statically compiled and linked directly into native or machine code for execution by the target platform (i.e., the operating system and hardware of the target processing system or platform). Native code or machine code is code that is compiled down to methods or instructions that are specific to the operating system and/or processor. In contrast, dynamic program language instructions are statically compiled into an intermediate language (e.g., bytecode), which may be interpreted or subsequently compiled by a just-in-time (JIT) compiler into native or machine code that can be executed by the target processing system or platform. Typically, the JIT compiler is provided by the VM that is hosted by the operating system of a target processing platform such as, for example, a computer system. Thus, the VM and, in particular, the JIT compiler, translates platform independent program instructions (e.g., Java bytecode, Common Intermediate Language (CIL), etc.) into native code (i.e., machine code that can be executed by an underlying target processing system or platform).

As more complex media devices and usages have been introduced to consumers, the desire to provide small, low-cost devices along with the desire to provide increased functionality has led to the use of networked client-server architectures. In these architectures, client media devices are networked to a central server or servers that are responsible for the actual execution of applications and the components of the user interface are then transmitted to the client devices. These devices are well suited for use in households where a central media server can distribute media content, games, and other applications or content to client media devices located in living rooms and other media presentation locations. The devices are also desirable in places where many client devices are connected to a central server. For example, a university may have many simple client devices distributed across a campus. On their own, the devices may not be capable of executing complex applications. However, the devices may be connected to a central server that executes applications and sends user interface components to the devices.

Recently, there has been a desire to provide client devices with which a user can interact. For example, the central server may render a user interface and send it to the client device. The client device can display the user interface and await feedback from the user. When the user provides feedback, the feedback is sent to the central server to be applied to the execution of the application and a new user interface is rendered and sent to the device. Typically, the user interface is sent as an image or other finally rendered object so that rendering on the client device is simplified. Thus, a client device with very little computational power can provide fully functional, complex applications.

A known method for allowing communication among networked devices is the Universal Plug and Play (UPnP) architecture. Under the UPnP architecture, when a device is connected to a network of devices, the device automatically obtains its own network address and sends a broadcast to announce its presence and its capabilities to other devices on the network. When other devices receive the broadcast, they in turn acknowledge their presence and capabilities according to a protocol defined as part of the UPnP standard. UPNP allows connection of various devices with little or no setup by users because devices automatically recognize each other without requiring configuration of the network parameters. UPnP is especially desirable in household media systems because of the ease with which devices can be connected to networks.

### BRIEF DESCRIPTION OF THE DRAWINGS

FIG. 1 is a block diagram of an example system for providing a remote-user-interface-capable managed runtime environment.

FIG. 2 is a flowchart representative of example machine-readable instructions that may be executed to implement the virtual machine manager of FIG. 1.

FIG. 3 is a flowchart representative of example machine-readable instructions that may be executed to implement the execution of an application in a spawned virtual machine.

FIG. 4 is a block diagram of an example processor system that may be used to implement the systems and methods disclosed herein.

### DETAILED DESCRIPTION

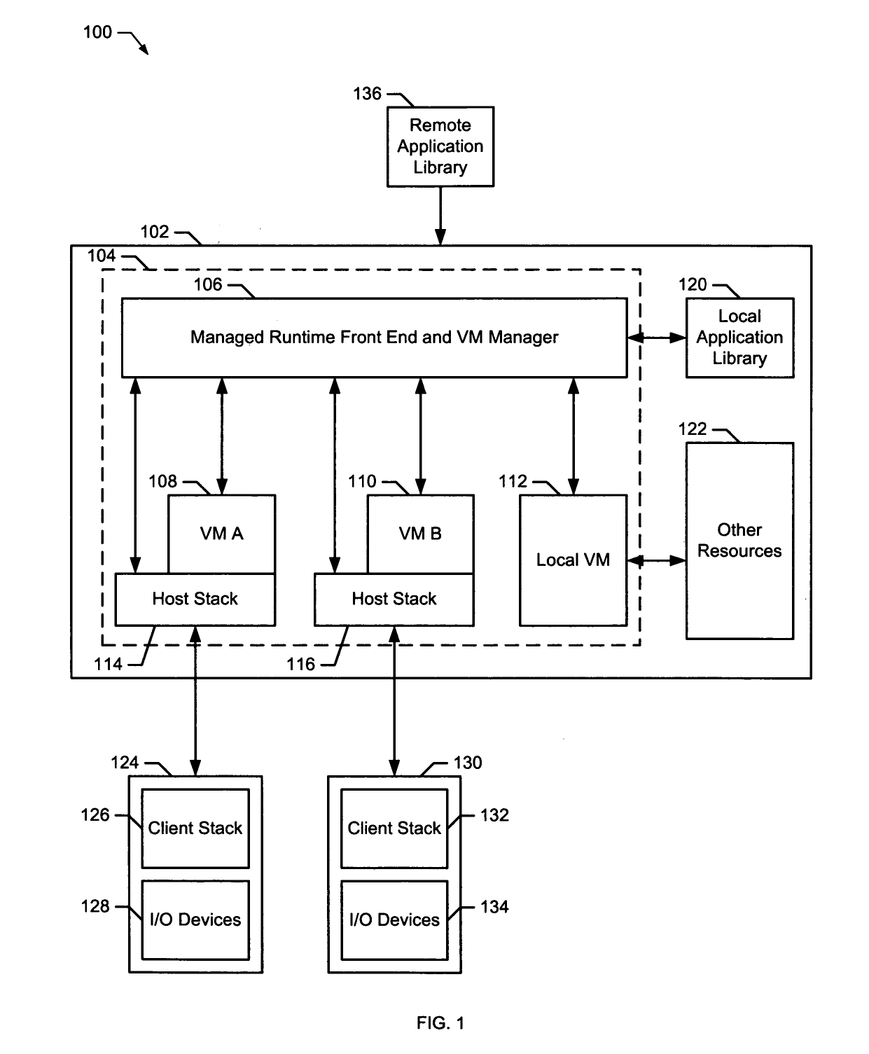

FIG. 1 is a block diagram of an example system 100 for providing a remote-user-interface capable managed runtime environment (MRTE). The example system 100 includes a computer 102 having a MRTE 104 thereon, a first client device 124, a second client device 130, and a remote application library 136. Although, for ease of illustration, only one computer 102 and two client devices 123 and 130 are shown in FIG. 1, persons of ordinary skill in the art will appreciate that other numbers of computers and/or client devices may be present in the system 100.

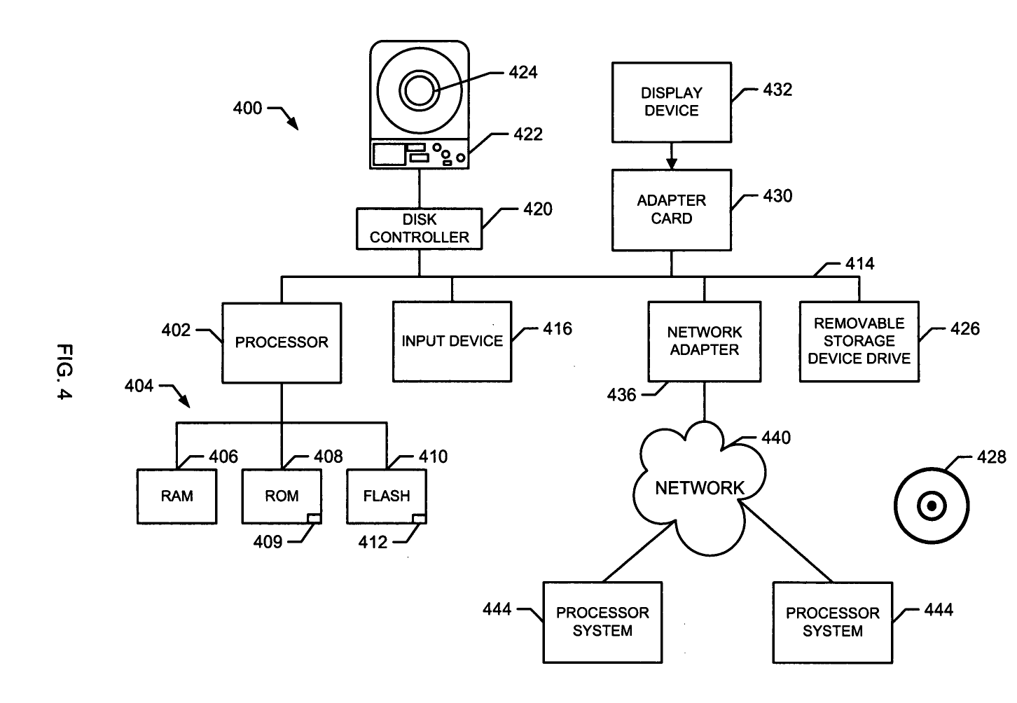

The computer 102 includes the MRTE 104, a local application library 120, and other resources 122. The computer 102 may be any computer system capable of hosting a MRTE such as, for example, an Intel processor based system, etc. The other resources 122 may be any resources or devices typically available in a computer system. For example, the other resources 122 may include a monitor, a keyboard, a mouse, system memory, video memory, hard disk memory, or any other resources. Example implementations of the computer 102 and the other resources 122 are described in further detail in conjunction with FIG. 4.

The computer 102 may be connected to one or more client devices using any available communication medium. In the example system 100, the first client device 124 and the second client device 130 are connected to the computer 102 over a home network using the Universal Plug and Play (UPnP) architecture. Of course, a person of ordinary skill in the art will recognize that any medium of providing communication between a computer and a client device may be used such as, for example, a TCP/IP network, a firewire network, a wireless network, a Bluetooth connection, universal serial bus connections, etc.

The example MRTE 104 includes a managed runtime front end and virtual machine manager (VMM) 106, a spawned virtual machine (VM) A 108 and a host stack 114, a spawned VM B 110 and a host stack 116, and a spawned local VM 112. The MRTE 104 running on the computer 102 provides a machine independent environment for handling user interface requests from client devices such as, for example, the first client device 124 and the second client device 130. In particular, the VMM 106 is capable of receiving a request for an application from a client device. The VMM 106 may use any protocol or architecture suitable for communication with a client device. In the example system 100, the VMM 106 communicates with client devices using the UPnP architecture.

The MRTE 104 includes a host stack 114 to handle communication between the computer 102 and the first client device 124. The MRTE 104 also includes a host stack 116 to handle communications between the computer 102 and the second client device 130. The host stacks 114 and 116 are capable of recognizing broadcasts from devices that are connected to the computer 102 via a network in accordance with the UPnP protocol. The host stacks 114 and 116 provide a standard medium for communication between devices. A person of ordinary skill in the art will recognize that more than two host stacks may be invoked to allow communication with more client devices. For example, three UPnP host stacks may be invoked to communicate with three client devices.

Returning to the description of the VMM 106, the VMM 106 is capable of accessing an application library to retrieve an application requested by a client device 124, 130. For example, in response to an application request from the client device 124, 130, the VMM 106 may access the local application library 120 on the computer 102 and/or may access the remote application library 136. The VMM 106 may spawn an instance of a VM to execute the application retrieved from the application library such as, for example, VM A 108 and/or VM B 110. The local application library 120 and the remote application library 136 contain a set of applications that may be retrieved for execution. The local application library 120 may be stored on any type of local media such as a flash memory, a hard drive memory, a compact disk, a digital versatile disk, or any other type of medium. The remote application library 136 may be connected to the computer 102 via any available communication method. For example, the remote application library 136 may be connected to the computer 102 via a local area network, a wide area network, an internet connection, or any other suitable connection.

The VM A 108 and/or the VM B 110 spawned by the VMM 106 are capable of executing the application(s) retrieved from the application library(ies) 120 and 136. The VM's 108 and 110 are further capable of transmitting the user interface components from the executed application to the requesting client devices 124 and 130. For example, VM A 108 may execute an application and render an image of the user interface provided by the application. The rendered image may be transmitted to the first device 124, 130 which requested the application. Example user interface components that may be transmitted include images, video streams, and sound. The VMs 108 and 110 of the illustrated example are further capable of receiving input from the client devices 124 and 130. For example, the VM A 108 may receive a signal indicative of user interaction with a user interface component at the first client device 124. The user may provide interaction through any method provided by the client device. The types of user interaction will be described in further detail below.

The first client device 124 and the second client device 130 include client stacks 126 and 132 and input/output (I/O) devices 128 and 134, respectively. The first and second client devices 124 and 130 may be any devices capable of displaying one or more user interface components and may be capable of receiving interaction from a user. For example, the client devices 124 and 130 may be a cell phone, a personal digital assistant, a set-top box, a media extender, a video gaming device, a digital video recorder, a personal computer, a “thin” client (a limited computing device comprising few hardware components and designed to be operated in a client/server environment), or any other suitable device. The client stacks 126 and 132 allow the client devices 124 and 130 to communicate with the host stacks 114 and 116 of the computer 102 and the MRTE 104. The client stacks 126 and 132 are capable of announcing that a device has joined the network, receiving user interface components, and transmitting user interaction information. In the example system 100, the client devices 124 and 130 communicate with the computer 102 using a UPnP connection. However, persons of ordinary skill in the art will recognize that any medium of communication between a client device and a server computer may be utilized.

To execute an application for the local machine, the VMM 106 may spawn a local VM 112. The local VM 112 may execute applications that may be used by the VM's 108 and 110 and/or may execute programs to allow interaction or control of the computer 102. The local VM 112 may utilize the local resources 122 that are available at the computer 102. For example, the local VM 112 may display a user interface on a local monitor, may output sound to speakers, may receive keyboard input, may receive input from a mouse, and/or may allow any other type of interaction.

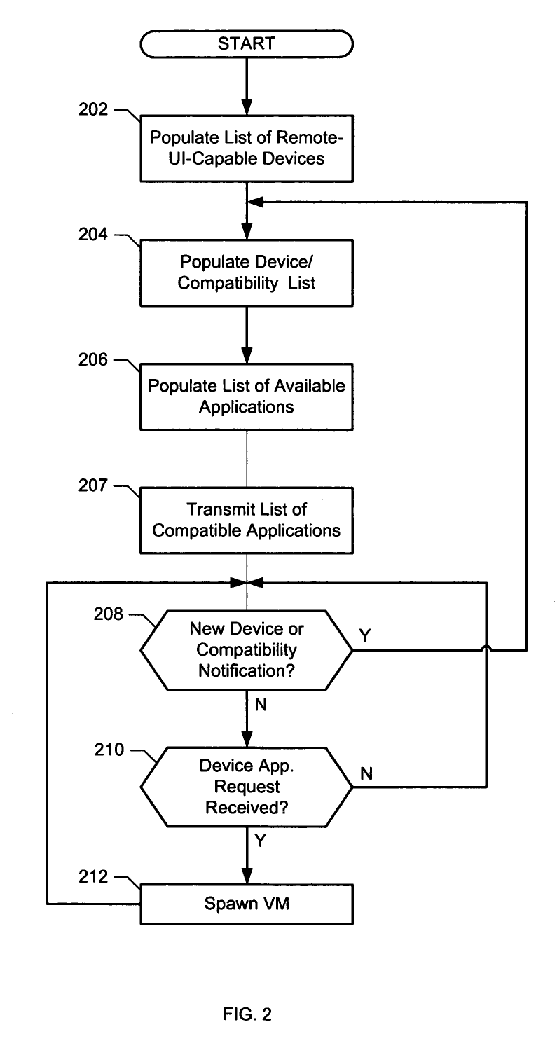

FIG. 2 is a flowchart representative of machine-readable instructions that may be executed by the MRTE 104 to implement the VMM 106 of FIG. 1. The VMM 106 starts by generating a list of devices that are in communication with the computer 102 and are capable of receiving a remote-user-interface (block 202). For example, the VMM 106 records the network addresses of the first client device 124 and the second client device 130. In the example system 100 of FIG. 1 which utilizes the UPnP architecture, the VMM 106 may determine available devices based on broadcasts received from such devices by the host stacks 114 and 116. Alternatively, the VMM 106 may broadcast a request for devices to announce themselves or may utilize any other method of determining devices that are present on the network.

The VMM 106 then analyzes each of the recognized devices to generate a list of capabilities for each of the client devices 124 and 130 (block 204). For example, the VMM 106 may determine that the first client device 124 has a keyboard connected and the second client device 130 has a keyboard and a game controller connected. The VMM 106 may use any available method to determine the device capabilities. For example, the VMM 106 may request a list of capabilities from the device, may receive a broadcast of available capabilities from the device, or may examine a list of known capabilities for certain devices.

The VMM 106 then generates a list of available applications (block 206). For example, the VMM 106 may query the local application library 120 and the remote application library 135 to determine a list of available applications. The VMM 106 may then generate a list of client devices that are compatible which each of the available applications. For example, if an application requires a game controller, only client devices that include a game controller will be listed as compatible devices. Once the list of available applications is generated (block 206), a list of compatible applications may be transmitted to each of the available devices (block 207). Alternatively, a standard set of applications may be known by all devices so that the list of applications does not need to be generated and/or to be transmitted to any of the devices.

After determining available devices and applications, the VMM 106 enters a loop illustrated by block 208 to 212. If a new device is connected to the computer 102, execution moves to block 204 to add the device to the list of available devices and to determine the capabilities of the device (block 208). Likewise, if a current device has a change in compatibility, execution moves to block 204 to determine the new list of compatibilities of the current device (also block 208). For example, if a game controller is connected to a client device, the client device may broadcast that a change in capabilities has been made. When the broadcast of the change is received by the VMM 106 through the host stacks 114 and 116, the VMM 106 will determine the current list of capabilities.

If a new device or compatibility notification is not received (block 208), the VMM 106 determines whether a device application request has been received (block 210). For example, a client device 124, 130 may request the execution of a word processor application. If a device application request has not been received (block 210), execution returns to block 208 to continue polling for device changes or application requests. When a client application request is received (block 210), the VMM 106 spawns a new VM to handle the execution of the application (block 212). The VM will transmit any user interface components that are generated by the application to the client device that requested the execution of the application. Likewise, the VM will apply any user interaction received from the client device to the execution of the application. After the VMM 106 spawns the VM, execution for the VMM 106 returns to block 208 to await further device changes or application requests.

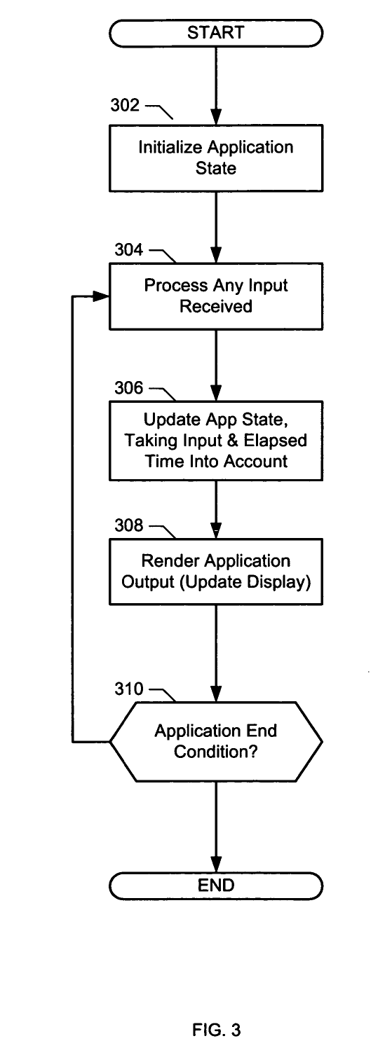

FIG. 3 is a flowchart representative of machine-readable instructions that may be executed to implement the execution of an application in a spawned VM. After a VM is spawned to execute an application, the VM initializes the application in the MRTE 104 (block 302). For example, the VM may execute the set of instructions listed in the application as the startup procedure. The VM may render and transmit the initial user interface to the client device at this time.

The VM then processes any input received from the client device (block 304). Input from the I/O devices at the client device is received from the client stack 126, 132 through the host stack 114, 116. Then, the VM updates the current application state (block 306). The input from the client device may be applied to the application as if the user were interacting directly with the computer 102. For example, if a user types a sentence on a keyboard at a client device, the sentence is applied to the input of the application executing the VM. Additionally, the client device may indicate that input is to be handled by the computer 102 or the MRTE 104. For example, the client device may indicate that an error has occurred and that the connection between the client device and the computer must be reset.

After any input is applied to the application and/or after a period of time elapses, the user interface components that are output by the device are transmitted to the client device (block 308). Any generated user interface components are sent by the host stack 114, 116 to the client stack 126, 132. The client device 124, 130 then displays these user interface components using the physical I/O devices available at the client device 124, 130. For example, if the application generates a three-dimensional object, an image of the three-dimensional object is rendered in the MRTE 104 on the computer 102 and the rendered image is then sent to the client device 124, 130 for display. Thus, very little rendering must be done on the client device 124, 130. The VM may automatically check the application periodically to determine if the user interface has changed and must be sent to the client device.

After any user interface components are sent to the client device, the VM determines whether the application has reached an end condition (block 310). The application may reach an end condition based on the normal execution of the application or based on a request by the user for the application to end. Additionally, the application might reach an end condition due to an error that has occurred such as, for example, an error with input provided by the user, a loss of connection to the client device, an error on the client device, etc. If the application has reached an end condition (block 310) the execution of the application is completed, and the VM spawned for execution of that application is terminated. If the application has not reached an end condition (block 310), the VM execution returns to block 304 to continue processing user input and sending user interface components to the client device.

In FIGS. 2-3, the machine-readable instructions comprise a program for execution by a processor such as the processor 406 shown in the example computer 400 discussed below in connection with FIG. 4. The program may be embodied in software stored on a tangible medium such as a CD-ROM, a floppy disk, a hard drive, a digital versatile disk (DVD), or a memory associated with the processor 406, but persons of ordinary skill in the art will readily appreciate that the entire program and/or parts thereof could alternatively be executed by a device other than the processor 406 and/or embodied in firmware or dedicated hardware in a well known manner. Although the example program is described with reference to the flowcharts illustrated in FIGS. 2-3, persons of ordinary skill in the art will readily appreciate that many other methods may alternatively used. For example, the order of execution of the blocks may be changed, and/or some of the blocks described may be changed, eliminated, or combined.

FIG. 4 is a block diagram of an example processor system 400 that may be used to implement the computer 102, the first client device 124, and/or the second client device 130 of FIG. 1. The example processor system 400 includes a processor 402, having associated system memory 404. The system memory 404 may include one or more of a random access memory (RAM) 406, a read only memory (ROM) 408 and a flash memory 410. The ROM 408 and the flash memory 410 of the illustrated example may respectively include boot blocks 409 and 412.

The processor 402, in the example of FIG. 4, is coupled to an interface, such as a bus 414 to which other peripherals or devices are interfaced. In the illustrated example, the peripherals interfaced to the bus 414 include an input device 416, a disk controller 420 communicatively coupled to a mass storage device 422 (i.e., hard disk drive) having a host protected area 424, and a removable storage device drive 426. The removable storage device drive 426 may include associated removable storage media 428, such as magnetic or optical media.

The example processor system 400 of FIG. 4 also includes an adapter card 430, which is a peripheral coupled to the bus 414 and further coupled to a display device 432.

The example processor system 400 may be, for example, a conventional desktop personal computer, a notebook computer, a workstation or any other computing device. The processor 402 may be any type of processing unit, such as a microprocessor from the Intel® Pentium® family of microprocessors, the Intel® Itanium® family of microprocessors, and/or the Intel XScale® family of processors.

The memories 406, 408, and 410, which form some or all of the system memory 404, may be any suitable memory devices and may be sized to fit the storage demands of the system 400. The ROM 408, the flash memory 410, and the mass storage device 422 are non-volatile memories. Additionally, the mass storage device 422 may be, for example, any magnetic or optical media that is readable by the processor 402.

The input device 416 may be implemented by a keyboard, a mouse, a touch screen, a track pad or any other device that enables a user to provide information to the processor 402.

The display device 432 may be, for example, a liquid crystal display (LCD) monitor, a cathode ray tube (CRT) monitor, or any other suitable device that acts as an interface between the processor 402 and a user via the adapter card 430. The adapter card 430 is any device used to interface the display device 432 to the bus 414. Such cards are presently commercially available from, for example, ATI Technologies, NVIDIA Corporation and other like vendors.

The removable storage device drive 426 may be, for example, an optical drive, such as a compact disk-recordable (CD-R) drive, a compact disk-rewritable (CD-RW) drive, a digital versatile disk (DVD) drive or any other optical drive. It may alternatively be, for example, a magnetic media drive. The removable storage media 428 is complimentary to the removable storage device drive 426, inasmuch as the media 428 is selected to operate with the drive 426. For example, if the removable storage device drive 426 is an optical drive, the removable storage media 428 may be a CD-R disk, a CD-RW disk, a DVD disk or any other suitable optical disk. On the other hand, if the removable storage device drive 426 is a magnetic media device, the removable storage media 428 may be, for example, a diskette, or any other suitable magnetic storage media.

The example processor system 400 also includes a network adapter 436 (i.e., a processor peripheral), such as, for example, an Ethernet card or any other card that may be wired or wireless. The network adapter 436 provides network connectivity between the processor 402 and a network 440, which may be a local area network (LAN), a wide area network (WAN), the Internet, or any other suitable network. As shown in FIG. 4, further processor systems 444 may be coupled to the network 440, thereby providing for information exchange between the processor 402 and the processors of the processor systems 444.

One of ordinary skill in the art will recognize that the order, size, and proportions of the memory illustrated in the example systems may vary. For example, the user/hardware variable space may be sufficiently larger than the main firmware instructions space. Additionally, although the forgoing discloses example systems including, among other components, software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the following describes example systems, persons of ordinary skill in the art will readily appreciate that the examples are not the only way to implement such systems.

Although certain apparatus, methods, and articles of manufacture constructed in accordance with the teachings of the invention have been described herein, the scope of coverage of this patent is not limited thereto. On the contrary, this patent covers every apparatus, method and article of manufacture fairly falling within the scope of the appended claims either literally or under the doctrine of equivalents.

What is claimed is:

1. A method of providing an interface of an application comprising:
receiving a request from a first device to execute an application at a second device, the first device being incapable of executing the application;
retrieving the application from an application library;
executing the application on the second device in a managed runtime environment;
transmitting at least a portion of an interface of the application from the second device to the first device; and
presenting the at least a portion of the interface of the application on the first device.

2. A method as defined in claim 1 further comprising:
at least one of retrieving, generating, or receiving a list of available applications from the application library;
determining which of the available applications are compatible with the first device; and
transmitting a list of compatible applications to the first device.

3. A method as defined in claim 1 wherein executing the application comprises spawning a virtual machine in the managed runtime environment to execute the application on the second device.

4. A method as defined in claim 1 further comprising at least one of retrieving, generating, or receiving a list of available client devices including the first device.

5. A method as defined in claim 1 further comprising:
receiving a user input at the first device;
communicating the user input to the second device; and
updating the application at the second device with the user input.

6. A method as defined in claim 1 wherein the first and second devices are coupled via a communication medium which operates via a Universal Plug and Play protocol.

7. A method as defined in claim 1 wherein the application is implemented in at least one of Java, C#, J#, VB.NET, or Jscript .NET.

8. A method as defined in claim 1 wherein the first device comprises a cell phone, a personal digital assistant, a set-top box, a media extender, a video gaming device, a digital video recorder, a personal computer, or a thin client.

9. An article of manufacture storing machine-readable instructions that, when executed, cause a first machine to:
receive a request from a second device to execute an application, the second device being incapable of executing the application;
retrieve the application from an application library;
execute the application in a managed runtime environment; and
transmit at least a part of an interface of the application to the first device.

10. An article of manufacture as defined in claim 9 wherein the machine-readable instructions further cause the first machine to:
at least one of retrieve, generate, or receive a list of available applications from the application library;
determine which of the available applications are compatible with the first device; and
transmit a list of compatible applications to the first device.

11. An article of manufacture as defined in claim 9 wherein the machine-readable instructions further cause the first machine to spawn a virtual machine in the managed runtime environment to execute the application.

12. An article of manufacture as defined in claim 9 wherein the machine-readable instructions further cause the first machine to at least one of retrieve, generate, or receive a list of available client devices including the first device.

13. An article of manufacture as defined in claim 9 wherein the machine-readable instructions further cause the first machine to:
receive a user input from the first device; and
update the application with the user input.

14. An article of manufacture as defined in claim 9 wherein the machine-readable instructions cause the first machine to operate in accordance with a Universal Plug and Play protocol.

15. An article of manufacture as defined in claim 9 wherein the application is implemented in at least one of Java, C#, J#, VB.NET, or Jscript .NET.

16. An article of manufacture of manufacture as defined in claim 9 wherein the first device comprises a cell phone, a personal digital assistant, a set-top box, a media extender, a video gaming device, a digital video recorder, a personal computer, or a thin client.

17. An apparatus to execute an application comprising:
a managed runtime environment;
a host stack to receive a request to execute an application from a first device with insufficient resources to execute the application;
a virtual machine to execute the application;
a virtual machine manager to spawn the virtual machine in the managed runtime environment, wherein the host stack transmits at least a portion of a user interface of the application from the virtual machine to the first device.

18. An apparatus as defined in claim 17 wherein the virtual machine manager at least one of retrieves, generates, or receives a list of available applications from an application library; determines which of the available applications are compatible with the first device; and transmits a list of compatible applications to the first device.

19. An apparatus as defined in claim 17 wherein the virtual machine receives a user input transmitted from the first device and updates the application at the second device with the user input from the first device.

20. An apparatus as defined in claim 17 wherein the host stack operates in accordance with the Universal Plug and Play protocol.

21. An apparatus as defined in claim 17 wherein the first device comprises a cell phone, a personal digital assistant, a set-top box, a media extender, a video gaming device, a digital video recorder, a personal computer, or a thin client.

22. A system comprising:
a first Universal Plug and Play(UPnP) device having a first set of resources;
a second UPnP device in communication with the first device, the second UPnP device having a second set of resources that is larger than the first set of sources; the second UPnP device including a virtual machine manager responsive to a request from the first UPnP device to spawn a virtual machine to execute an application requiring more resources than the first set of resources and less than the second set of resources; wherein the virtual machine provides an interface portion of the application to the first UPnP device for presentation on the first UPnP device.

23. A system as defined in claim 22 wherein the first and second device are in communication via at least one of a wireless network, a TCP/IP network, a universal serial bus connection, a firewire network or a Bluetooth connection.
